(19) United States
(12) Patent Application Publication
(10) Pub. No.: US 2017/0269736 A1
(43) Pub. Date: Sep. 21, 2017

(54) HYBRID SCAN TYPE TOUCH DETECTING METHOD AND APPARATUS IN FLEXIBLE TOUCH SCREEN PANEL

(71) Applicant: Crucialtec Co., Ltd., Asan-si (KR)

(72) Inventor: Ick Chan JEONG, Hwaseong-si (KR)

(21) Appl. No.: 15/505,564

(22) PCT Filed: Aug. 17, 2015
(86) PCT No.: PCT/KR2015/008555

§ 371 Date: Feb. 21, 2017

(30) Foreign Application Priority Data
Aug. 19, 2014 (KR) 10-2014-0107770
Nov. 13, 2014 (KR) 10-2014-0158128

(51) Int. Cl. G06F 3/044

(52) U.S. Cl. CPC G06F 3/044; G06F 2203/04104

(57) ABSTRACT

The present invention provides a touch detection method and apparatus. The touch detection apparatus includes: a plurality of sensor nodes comprising a single area node configured as a part of a single sensor pad among sensor pads disposed in multiple rows and columns on a single layer, and a shared area node configured so that parts of at least two sensor pads are alternately arranged; a touch detection unit configured to detect a first touch generation signal according to a change in touch capacitance generated between each sensor pad and a touch generation means, and to detect a second touch generation signal according to a change in mutual capacitance generated between sensor pads adjacent in a first direction; and a touch information processing unit configured to process touch information generated in the single area node and the shared area node based on the first and second touch generation signals.

### CROSS-REFERENCE TO RELATED APPLICATIONS

This application is the National Stage Entry of International Patent Application No. PCT/KR2015/008555, filed on Aug. 17, 2015, and claims priority from and the benefit of Korean Patent Application No. 10-2014-0107770, filed on Aug. 19, 2014 and Korean Patent Application No. 10-2014-0158128, filed on Nov. 13, 2014, all of which are hereby incorporated by reference for all purposes as if fully set forth herein.

### BACKGROUND

Field

Exemplary embodiments of the present invention relate to a touch detection method and apparatus, and more particularly, to a touch detection method and apparatus capable of exactly detecting a multi-touch.

Discussion of the Background

A touch screen panel is a device which receives an instruction from a user by touching a letter or a feature displayed on a screen of an image display device with a human finger or another contact tool. The touch screen panel is attached to the image display device and converts a touch position touched by the human finger into an electrical signal. The electrical signal is used as an input signal.

Generally, a touch detection apparatus determines whether a touch occurs and a touch generation position by detecting a touch capacitance formed in a relationship between a touch generation means and a sensor pad. When a touch generation means approaches a sensor pad, a capacitance formed in the sensor pad is different in comparison to a capacitance formed when the touch generation means does not approach the sensor pad, and a touch generation position and a touch generation area may be determined according to a size of the capacitance.

However, when a sectional area of the touch generation means is very small in comparison to an area of the sensor pad, there is a problem in which touches are determined to occur at the same position, that is, a central point of a corresponding sensor pad, even when the touches occur at different positions on one sensor pad.

Accordingly, a sensor pad shown in FIG. 1 has been developed so that a touch generation position is exactly determined even when a touch by a touch generation means having a small sectional area occurs.

In this specification, the terms “row” and “column” are understood as having a relative meaning. In detail, in the following description, the terms “row” and “column” are used interchangeably, and all cases should be understood as being included in the scope of the present invention.

Referring to FIG. 1, sensor pads 11 arranged in a plurality of rows and columns are arranged in a touch panel 10.

A plurality of bar type strips b having a longitudinal direction parallel to a column direction are formed at longitudinal edges of each of the sensor pads 11. The bar type strips b are formed only at a lower edge of the sensor pad 11 arranged uppermost in the same column, and the bar type strips b are formed only an upper edge of the sensor pad 11 arranged lowermost in the same column.

FIG. 1 illustrates an example in which the bar type strips b are formed only in the column direction and the sensor pads 11 are interlocked in the column direction. The bar type strips b may be formed in a row direction of the sensor pads 11 and the sensor pads 11 adjacent in the row direction may be interlocked. Further, the bar type strips b may be formed in both of the column direction and the row direction. In this case, adjacent sensor pads 11 are interlocked in the row direction as well as in the column direction.

For convenience of explanation, all exemplary embodiments will be described hereinafter under the assumption that the bar type strips b are formed in the column direction of the sensor pad 11 and the sensor pads 11 adjacent in the column are interlocked.

The bar type strips b of the sensor pads 11, which are arranged in the same column and are adjacent to each other, are not in electrical contact with each other and are arranged to be interlocked.

A case in which touches occur at positions A and B of a first sensor pad 11a and a second sensor pad 11b which are adjacent to each other in the column direction will be described hereinafter.

First, when a touch occurs at position A, a touch generation signal output from the first sensor pad 11a (a difference in values of output signals when the touch does not occur and when the touch occurs) is great among all of the sensor pads 11, and accordingly, it is determined that a touch position is included in the first sensor pad 11a.

When a touch occurs at position B, touch generation signals are output from the first sensor pad 11a and the second sensor pad 11b, but a position which is slightly closer to the first sensor pad 11a of an area between the first sensor pad 11a and the second sensor pad 11b may be determined as a touch generation position since a relatively greater touch generation signal is output from the first sensor pad 11a.

That is, whether the touch generation position is an area of the first sensor pad 11a or an area shared with the second sensor pad 11b adjacent in the column direction may be determined even when a touch occurs in an upper area of the first sensor pad 11a by the sensor pads 11 being arranged as in FIG. 1.

A case in which touches simultaneously occur at a plurality of positions will be described.

FIGS. 2A-2D are diagrams for describing a case in which touches simultaneously occur at a plurality of positions, that is, a multi-touch occurs at the sensor pad 11 shown in FIG. 1.

In FIGS. 2A-2D, assume that a circle drawn in a dashed line represents a position at which a touch by a touch generation means occurs, a touch generation signal of 100% is obtained when the touch occurs on only a specific sensor pad, and a touch generation signals of 50% is obtained from each of two sensor pads when a touch occurs at an area in which bar type strips of two sensor pads are interlocked.

First, referring to FIG. 2A, a touch occurs at an area in which bar type strips of a sensor pad A and a sensor pad B are interlocked, and simultaneously, a touch occurs at an area in which bar type strips of the sensor pad B and a sensor pad C are interlocked. In the case shown in FIG. 2A, the touch generation signals of 50%, 100%, and 50% are respectively obtained from the sensor pad A, the sensor pad B, and the sensor pad C. Accordingly, the case shown in FIG. 2A may be the same as a case in which a touch by a touch generation means having a very great sectional area occurs around the sensor pad B, and a detection regarding a multi-touch may not be correctly performed.

Similarly, as shown in FIG. 2B, when assuming that a touch occurs at an area in which the bar type strips of the sensor pad A and the sensor pad B are interlocked, and simultaneously, a touch occurs at an area in which only the sensor pad C is arranged, the touch generation signals of 50%, 50%, and 100% are respectively obtained from the sensor pad A, the sensor pad B, and the sensor pad C. In this case, the case shown in FIG. 2B may be the same as a case in which a conductive material (for example, liquid having conductivity such as water) around the sensor pad C is arranged to be elongated to the sensor pad A, and a detection regarding a multi-touch may not be exactly performed. However, when the conductive material is arranged to be elongated from the sensor pad A to the sensor pad C, it is determined that a touch is not performed by one touch generation means and a multi-touch is performed through correction of a touch coordinate when processing the touch generation signal since a touch generation signal of 200% (=50+100%+50%) should be obtained from the sensor pad B, but, in this case, it is difficult to exactly determine whether any portion of the sensor pad C is a touch generation position.

Further, in FIG. 2C, the touch generation signal of 50% is obtained from all of the sensor pad A, the sensor pad B, the sensor pad C, and a sensor pad D, but it is determined that a multi-touch occurs through correction using software since the touch generation signal of 200% is obtained from each of the sensor pad B and the sensor pad C when a touch by one object occurs.

Meanwhile, in a case shown in FIG. 2D, since the touch generation signal of 50% is obtained from the sensor pad A and the sensor pad B, a touch generation signal is not obtained from the sensor pad C, and the touch generation signal of 100% is obtained from the sensor pad D, it may be determined that a multi-touch occurs having the sensor pad C as a boundary even without software correction.

As described above, in the touch panel 10 shown in FIG. 1, a touch may be determined as a multi-touch when a distance among a plurality of touch generation positions is equal to or more than that of the case shown in FIG. 2B.

Accordingly, when a multi-touch occurs, there is a need for the touch detection apparatus to determine a touch as a multi-touch even when a distance between touch generation positions is small and to exactly determine each of the touch generation positions.

### SUMMARY

The present invention is directed to providing a hybrid scan type touch detection method and apparatus which may exactly determine a touch generation position even when a multi-touch occurs within a short distance.

The present invention is also directed to providing a hybrid scan type touch detection method and apparatus which removes a light transmission characteristic difference of each area by making patterns of an area in which a sensor pad is formed and an area in which a signal line is formed similarly.

The present invention is further directed to providing a hybrid scan type touch detection method and apparatus which prevent a color temperature difference and a color difference per unit area from being generated when the touch detection apparatus is stacked on a display device.

One aspect of the present invention provides a touch detection apparatus, including: a plurality of sensor nodes including a single area node configured as a portion of a single sensor pad among sensor pads arranged in a plurality of rows and columns in a single layer, and a shared area node configured so that portions of at least two sensor pads are alternately arranged; a touch detection unit configured to detect a first touch generation signal generated according to a change of a touch capacitance generated between each of the sensor pads and a touch generation means, and to detect a second touch generation signal generated according to a change of a mutual capacitance generated between sensor pads adjacent in a first direction; and a touch information processing unit configured to process touch information generated in the single area node and touch information generated in the shared area node based on the first and second touch generation signals.

At least one end of each of the sensor pads may be formed to have a plurality of bar type strips extended in the first direction, and the sensor pads adjacent in the first direction may configure the shared area node in which the plurality of bar type strips are arranged to be interlocked.

A dummy pad having longitudinal direction parallel to the first direction may be formed at an edge of the plurality of bar type strips in a second direction perpendicular to the first direction.

A plurality of grooves may be formed at an edge of the sensor pad in the first direction in an inner direction of the sensor pad, and a longitudinal direction of the grooves may be parallel to the first direction.

Depths of the grooves may be formed to be periodically increased or decreased based on the second direction perpendicular to the first direction.

One or more slits having longitudinal directions parallel to a column direction in which the sensor pad is arranged may be formed inside an area of the sensor pad.

At least a portion of line segments parallel to the first direction configuring the sensor pad may be formed in a saw pattern.

Each of the sensor pads may be connected to a driving unit including the touch detection unit and the touch information processing unit through a signal line, and the number of the sensor pads may be smaller than the number of the sensor nodes.

The touch detection unit may detect the first touch generation signal using a self-capacitive method in the single area node and detect the second touch generation signal using a mutual-capacitive method in the shared area node. An operation of detecting the touch generation signal using the self-capacitive method and an operation of detecting the touch generation signal using the mutual-capacitive method may be alternately and repeatedly performed.

When the first touch generation signal and the second touch generation signal detected in the single area node and the shared area node at the same sensor pad have a predetermined value or more, the touch information processing unit may determine that a multi-touch occurs at the same sensor pad.

When the second touch generation signal is detected in all of shared area nodes of a specific sensor pad and the first touch generation signal detected in the specific sensor pad has less than a predetermined value, the touch information processing unit may determine that a multi-touch occurs in which a touch occurs in each of the shared area nodes of the specific sensor pad.

The touch detection unit may detect the second touch generation signal based on a change value of an output voltage of another sensor pad generated by transiently changing a potential of the specific sensor pad among the sensor pads configuring the shared area node.

Another aspect of the present invention provides a touch detection method, including: detecting a first touch generation signal according to a change of a touch capacitance on a plurality of sensor pads which are arranged in a plurality of rows and columns in a single layer and form the touch capacitance through a relationship with a touch generation means; detecting a second touch generation signal according to a change of a mutual capacitance between the sensor pads adjacent in a first direction; and processing touch information generated in a single area node configured as a portion of a single sensor pad and a shared area node, in which portions of two sensor pads are configured to be alternately arranged, based on the first and second generation signals.

The single area node and the shared area node may be alternately arranged in the first direction, and the detecting of the first touch generation signal and the detecting of the second touch generation signal may be repeatedly and alternately performed on the single area node and the shared area node which are arranged in the first direction.

The first touch generation signal may be detected using a self-capacitive method, and the second touch generation signal may be detected using a mutual-capacitive method.

The detecting of the first touch generation signal and the detecting of the second touch generation signal may be alternately performed.

According to an exemplary embodiment of the present invention, in a touch panel configured with sensor pads which are interlocked in a predetermined direction, whether a touch occurs in any one of an area in which a sensor pad is independently arranged and an area in which sensor pads are interlocked can be exactly detected by mixing a plurality of capacitive touch detection methods.

Also, according to an exemplary embodiment of the present invention, since whether a touch occurs in the area in which the sensor pads are interlocked is determined using the mutual-capacitive touch detection method, a touch generation position can be exactly detected even when a multi-touch occurs at positions which are adjacent to each other.

Further, according to an exemplary embodiment of the present invention, a light transmission characteristic difference of each area of the touch panel can be removed by forming grooves and slits in the sensor pad and forming widths and distances of the grooves and the slits to be constant.

Moreover, according to an exemplary embodiment of the present invention, a color temperature difference and color difference occurring in the touch panel can be minimized by forming a side edge, the slit, the groove, a dummy pad, etc. of the sensor pad in a saw pattern.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a configuration of a touch panel of a conventional touch detection apparatus.

FIGS. 2A-2D are diagrams for describing touch detection operations of the touch panel shown in FIG. 1.

FIG. 3 is a diagram illustrating a configuration of a touch detection apparatus according to an exemplary embodiment of the present invention.

FIGS. 4 and 5 are diagrams for describing a touch detection method according to an exemplary embodiment of the present invention.

FIG. 6 is a circuit diagram illustrating a configuration of a touch detection unit according to an exemplary embodiment of the present invention.

FIG. 7 is a diagram illustrating a configuration of a sensor pad of the touch detection apparatus according to the exemplary embodiment of the present invention.

FIG. 8 is a diagram illustrating a configuration of a sensor pad of a touch detection apparatus according to another exemplary embodiment of the present invention.

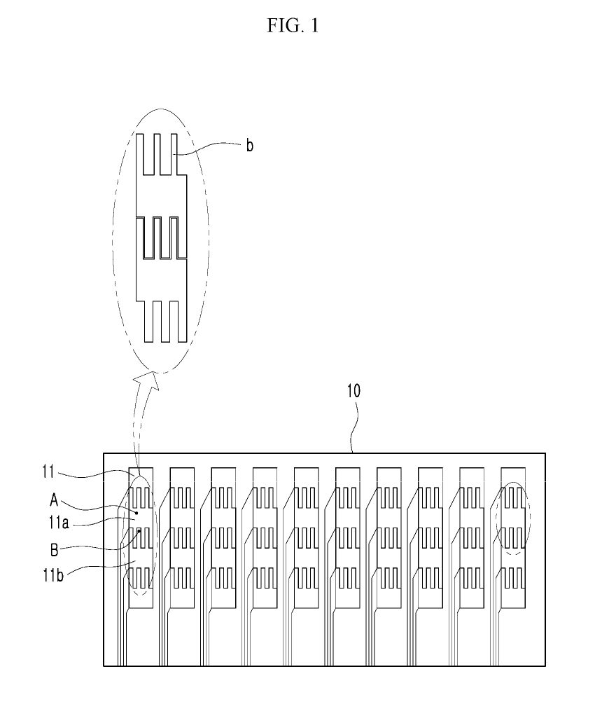

### DETAILED DESCRIPTION OF EXEMPLARY EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, the present invention will be described with reference to the accompanying drawings. The present invention may be implemented in various forms, and accordingly, is not limited to embodiments described herein. In order to clearly describe the present invention, a description of a portion which is not related to the present invention will be omitted, and like reference numerals represent like components throughout the specification.

Throughout the specification, it should be understood that when an element is referred to as being “connected” or “coupled” to another element, the element can be directly connected or coupled to the other element or intervening elements may be present. Further, it should be understood that the terms “comprises,” “comprising,” “includes,” and/or “including,” do not preclude one or more other components when used herein and further include one or more components unless stated otherwise.

Hereinafter, exemplary embodiments of the present invention will be described in detail with reference to the accompanying drawings.

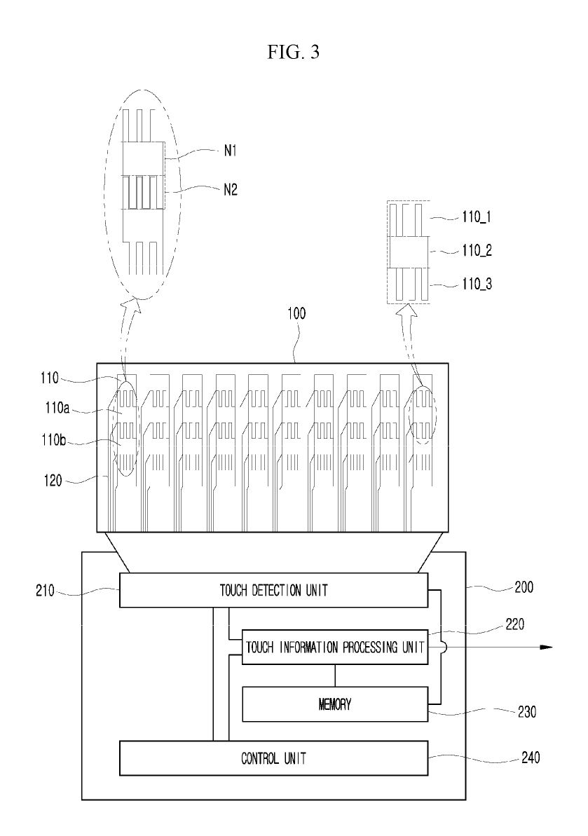

FIG. 3 is a diagram illustrating a configuration of a touch detection apparatus according to an exemplary embodiment of the present invention.

Referring to FIG. 3, the touch detection apparatus according to the exemplary embodiment of the present invention may include a touch panel 100 and a driving unit 200.

The touch panel 100 may include a plurality of sensor pads 110 which are arranged in a plurality of rows and columns in a single layer. Each of the plurality of sensor pads 110 may be connected to the driving unit 200 through one signal line 120.

The driving unit 200 may include a touch detection unit 210, a touch information processing unit 220, a memory 230, and a control unit 240, and may be implemented by one or more integrated circuit (IC) chips. The touch detection unit 210, the touch information processing unit 220, the memory 230, and the control unit 240 may be independently implemented, or two or more components may integrally be implemented.

The touch detection unit 210 may include a plurality of switches connected to the signal line 120, a plurality of capacitors, and a plurality of impedance devices, and may further include a multiplexer for selecting the sensor pad 110 for detecting a touch. According to the exemplary embodiment, the touch detection unit 210 may select a specific sensor pad 110 through the multiplexer, and detect whether a touch occurs using a signal output from the corresponding sensor pad 110.

The sensor pad 110 may generate touch capacitance through a relationship with a touch generation means, and whether a touch occurs at the corresponding sensor pad 110 may be detected by detecting an output signal because a signal output from the sensor pad 110 is different according to the touch capacitance. The touch detection unit 210 may drive circuits for detecting a touch by receiving a signal from the control unit 240, and output a voltage corresponding to a touch detection result. Further, the touch detection unit 210 may include an amplifier and an analog-to-digital converter, and convert, amplify or digitize a difference of output signals of sensor pads 110 and store it in the memory 230.

The touch detection unit 210 according to the exemplary embodiment of the present invention may perform touch detection on each of the sensor pads 110 by mixing touch detection methods.

A first method may be a self-capacitive method of selecting a specific sensor pad 110 and detecting a touch generation signal according to a change of a touch capacitance formed between a touch generation means and the corresponding sensor pad 110 that is touched itself. A second method may be a mutual-capacitive method of detecting a touch generation signal according to a change of a mutual capacitance between the specific sensor pad 110 and an adjacent sensor pad 110 according to whether the touch generation means exists thereto.

The touch detection unit 210 may perform the touch detection on the sensor pads 110 by mixing the first method and the second method. In the present invention, a touch detection method in which the touch detection unit 210 uses the first method and the second method by mixing them may be referred to as a “hybrid scan method.” This will be described in detail below.

The touch information processing unit 220 may process a digital voltage stored in the memory 230 and generate necessary information such as whether a touch occurs, a touch area, touch coordinates, etc.

The control unit 240 may control the touch detection unit 210 and the touch information processing unit 220, and may include a micro control unit (MCU) and perform predetermined signal processing through firmware.

The memory 230 may store predetermined data used for calculating the digital voltage and touch detection, the touch area, and the touch coordinates based on a difference of voltage changes detected by the touch detection unit 210 or data received in real time.

The sensor pad 110 of the touch panel 100 according to the exemplary embodiment of the present invention may be divided into totally three parts of an upper subpad 110_1, a middle subpad 110_2, and a lower subpad 110_3.

The middle subpad 110_2 may be formed in a rectangular shape, and the upper subpad 110_1 and the lower subpad 110_3 may be arranged by being electrically connected at the top and bottom thereof in a column direction based on the middle subpad 110_2 formed in the rectangular shape.

The upper subpad 110_1 and the lower subpad 110_3 may be formed in a shape that includes a plurality of bars having longitudinal directions parallel to the column direction. That is, at least one side of the sensor pad 110 may be configured as a plurality of bar type strips extended in the column direction.

In FIG. 3, an example in which each of the upper subpad 110_1 and the lower subpad 110_3 includes three bars is illustrated, but each of the upper subpad 110_1 and the lower subpad 110_3 may include two or four or more bars.

Since the upper subpad 110_1 and the lower subpad 110_3 are formed in the bar shape, the upper subpad 110_1 and the lower subpad 110_3 may overlap in an electrically insulated state in a corresponding area with another sensor pad 110 adjacent in the column direction. In other words, sensor pads that are adjacent in the column direction may be arranged to be interlocked in a state in which bar type strips thereof are insulated from each other.

The bar type strips of the upper subpad 110_1 may be interlocked in the same plane in a state which is mutually insulated with the bar type strips configuring the lower subpad of another sensor pad adjacent to the top of the upper subpad 110_1 in the column direction with a corresponding sensor pad 110, and the bar type strips of the lower subpad 110_3 may be interlocked in the same plane in a state which is mutually insulated with the bar type strips configuring the upper subpad of another sensor pad adjacent to the bottom of the lower subpad 110_3 in the column direction of the corresponding sensor pad 110.

Interlocking between the first subpad and the second subpad may be understood as meaning that the bar type strips configuring the second subpad are arranged in gaps between the bar type strips configuring the first subpad.

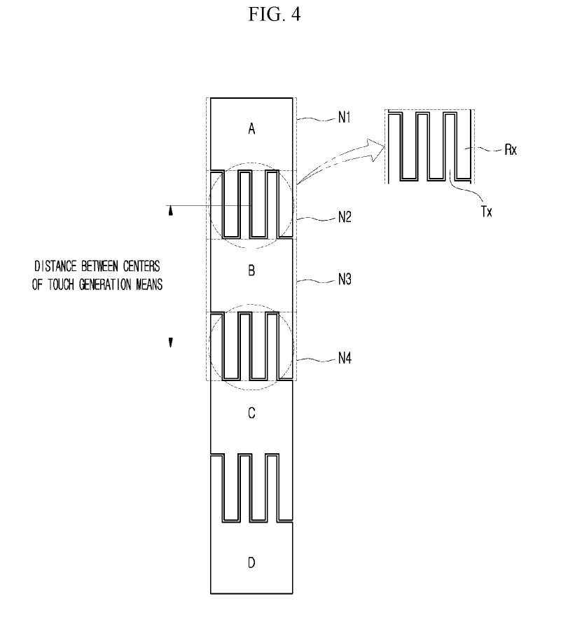

FIG. 4 is a diagram for describing a method of detecting touches by a touch generation means when the touches simultaneously occur at a plurality of positions in the touch detection apparatus shown in FIG. 3.

In the touch panel 100 shown in FIGS. 3 and 4, an example in which m (m is a natural number) sensor nodes N1 and N2 are formed in one column may be described.

The sensor nodes N1 and N2 may be a unit which detects whether a touch occurs, and the sensor nodes N1 and N2 may be divided into a single area node N1 in which one sensor pad 110 is independently arranged and a shared area node N2 in which at least two sensor pads 110 are arranged.

A part of a sensor pad 110a may be independently arranged in the single area node N1, and a part of a sensor pad 110a and a part of b sensor pad 110b may be arranged in the shared area node N2 which is adjacent to the single area node N1 in the column direction. Further, a plurality of bar type strips extended in one direction may be arranged to be interlocked with each other. Accordingly, the single area node N1 may be defined as a node in which there is no strip.

The single area node N1 and the shared area node N2 may be alternately formed in the column direction in one column.

In the example shown in FIG. 3, one sensor pad 110 may be arranged with one single area node N1 and two shared area nodes N2 which are adjacent in the column direction around the single region node N1.

Due to the above arrangement, the number of sensor pads 110 arranged in one column may be smaller than the number of sensor nodes N1 and N2 present in one column.

In the example of FIG. 3, the number of sensor pads 110 arranged in one column is 5, but the number of sensor nodes N1 and N2 formed by the five sensor pads 110 is totally 9. When generalizing this, the number of sensor nodes N1 and N2 formed by n sensor pads 110 is “2(n−1)+1” when n sensor pads 110 are arranged in one column.

Accordingly, when compared to a conventional method, a column having the same length may be configured using a much smaller number of sensor pads 110, and the number of columns may be further increased using the much smaller number of sensor pads 110. That is, a touch panel having the same area may be implemented using the same number of sensor pads 110 as the convention method, and the number of columns may be further increased. In other words, a touch panel having the same area may be implemented using the same number of channels as the convention method, and the number of columns may be further increased.

Accordingly, resolution may be increased when determining whether a touch occurs in the row direction. Further, since whether a touch occurs in each of the single area node N1 and the shared area node N2 may be determined, the resolution may be maintained as it is when determining whether a touch occurs in the row direction.

Hereinafter, touches which simultaneously occur at a plurality of positions may be referred to as a “multi-touch.”

Assume that touches occur in the second node N2, which is the shared area node in which a part of the sensor pad A and a part of the sensor pad B are arranged together, and in a fourth node N4, which is a shared area node in which a part of the sensor pad B and a part of the sensor pad C are arranged together. An area formed by a circle drawn with a dashed line in FIG. 4 may be a position at which the touch occurs.

Meanwhile, assume that a touch generation signal of 100% is obtained by performing a touch detection operation of a self-capacitive method on a corresponding sensor pad when a touch occurs in single area nodes N1 and N3 in which one sensor pad is independently arranged, and a touch generation signal of 50% is obtained by performing the touch detection operation of the self-capacitive method on each of two sensor pads at which touches occur when the touches occur in the shared area nodes N2 and N4 in which the two sensor pads are arranged together. Here, for example, the touch generation signal may correspond to a difference of values of output signals obtained from corresponding sensor pads when the touch does not occur and when the touch occurs.

The touch detection operation has to be performed on the first node N1 in order to detect a touch generation position. Since the first node N1 is the single area node in which the sensor pad A is independently arranged, the touch detection operation may be performed with the self-capacitive method by selecting the sensor pad A. Since the touch occurs in the second node N2 which is the shared area node, the touch generation signal of 50% may be obtained from the sensor pad A.

Meanwhile, the touch detection operation may be performed on the second node N2 below. Since the second node N2 is the shared area node in which the sensor pad A and the sensor pad B are arranged together, the touch detection operation may be performed on the second node N2 with a mutual-capacitive method.

Since a bar type strip of the sensor pad A and a bar type strip of the sensor pad B are arranged to be electrically separated from each other and to intersect in the second node N2 which is the shared area node, a mutual capacitance thereof may be formed between the sensor pad A and the sensor pad B.

When the touch occurs in the second node N2, an amount of the mutual capacitance may be changed since this is the same as a state in which a conductive material is included between the sensor pad A and the sensor pad B. Accordingly, whether a touch occurs in the second node N2 in which the sensor pad A and the sensor pad B are arranged together may be determined by determining whether the amount of the mutual capacitance between the sensor pad A and the sensor pad B has changed.

When applying an electrical signal to any one of the sensor pad A and the sensor pad B and obtaining an output signal from the remaining one, different output signals may be obtained according to whether the touch generation means exists between the sensor pad A and the sensor pad B. That is, different output signals may be obtained in a state in which the touch does not occur in the second node N2 and in a state in which the touch occurs in the second node N2.

For example, in the touch detection method using the mutual-capacitive method, an electrical signal may be applied to a transmission electrode Tx using the sensor pad A as the transmission electrode Tx and a response signal corresponding to the electrical signal may be obtained from a reception electrode Rx using the sensor pad B as the reception electrode Rx. The sensor pad B may be used as the transmission electrode Tx and the sensor pad A may be used as the reception electrode Rx.

In FIG. 4, since the touch occurs in the second node N2, a signal different from that of when the touch does not occur may be obtained from the sensor pad B used as the reception electrode Rx. That is, the touch generation signal of 100% may be detected in the second node N2. Accordingly, whether a touch occurs in the second node N2 may be determined by performing the mutual-capacitive touch detection method on the second node N2.

Since the third node N3 is the single area node in which the sensor pad B is independently arranged, whether the touch occurs in the third node N3 may be determined by performing the self-capacitive touch detection method on the sensor pad B like in the first node N1. Since touches occur in the second node N2 in which the portion of the sensor pad B is arranged together with the sensor pad A and the fourth node N4 in which a portion of the sensor pad B is arranged together with the sensor pad C, the touch generation signal of 100% (=50%+50%) may be obtained by performing touch detection on the sensor pad B.

Since the fourth node N4 is the shared area node in which the sensor pad B and the sensor pad C are arranged together, touch detection may be performed on the fourth node N4 like in the second node N2. Since any one of the sensor pad B and the sensor pad C which are arranged together in the fourth node N4 may be used as the transmission electrode Tx and the other one may be used as the reception electrode Rx, the touch detection operation may be performed with the mutual-capacitive method. Different signals may be output according to whether a touch occurs regardless of whether any sensor pad is used as the reception electrode Rx, and thus the touch may be confirmed as occurring in the fourth node N4. That is, the touch generation signal of 100% may be obtained from the fourth node N4.

When briefly describing the touch detection on the first to fourth nodes N1 to N4 described above, it may be seen that the touch generation signals of 50% and 100% are respectively obtained from the sensor node A and the sensor node B using the self-capacitive touch detection method and that the touches by the touch generation means occur in the second node N2 in which the sensor pad A and the sensor pad B are arranged together and the fourth node N4 in which the sensor pad B and the sensor pad C are arranged together using the mutual-capacitive touch detection method.

When the touch generation signal by one touch generation means is obtained, a touch generation signal of 200% may be obtained from the sensor pad B when detecting whether a touch occurs in the third node N3 because the center of the touch generation means is located in the third node N3. However, since the touch generation signal of 50% is obtained from the second node N2 in which the portion of the sensor pad B is arranged and the touch generation signal of 50% is obtained from the fourth node N4 and accordingly the touch generation signal of 100% is obtained from the sensor pad B, it may be seen that the touch generation signals obtained from the second node N2 and the fourth node N4 are not output by one touch generation means.

In other words, when a touch generation signal of a predetermined value (for example, 100%) or more is obtained from each of the two shared area nodes N2 and N4 formed by a corresponding sensor pad in a specific sensor pad, a touch may be determined as occurring in each of the two shared area nodes N2 and N4 when the touch generation signal obtained from the single area node N3 in which the corresponding sensor pad is independently arranged is less than a predetermined value less than 200% or 100%.

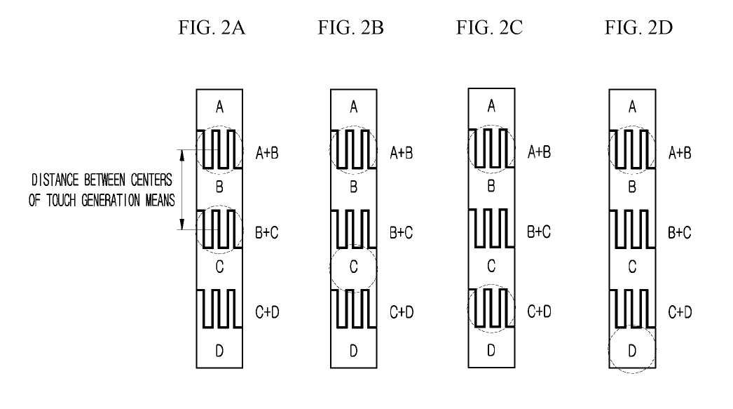

Accordingly, a multi-touch having a predetermined distance or more may be detected at the same sensor pad, and a position of each touch may be detected. In the description regarding the case of FIG. 2A in which a distance between touch generation positions is the same as that shown in FIG. 4, detection regarding a multi-touch may be impossible using only the self-capacitive touch detection method. However, according to the hybrid scan method of the present invention, touch position may be exactly determined even for a multi-touch within a short distance between touch generation means.

Moreover, when a touch generation signal detected in a single area node of a specific sensor pad has a predetermined value or more and a touch generation signal detected in a shared area node of a corresponding sensor pad has also the predetermined value or more, touches may be determined as occurring in both the single area node and the shared area node of the single sensor pad, that is, a multi-touch may be determined as occurring on the single sensor pad.

According to the conventional art, since only a one-time scan is performed on a specific sensor pad, it is not exactly determined whether a touch occurs at any position even when a touch generation signal is detected at a specific sensor pad. However, according to the exemplary embodiment of the present invention, since a touch generation signal which has the predetermined value or more is detected at a shared area node of a single sensor pad and a touch generation signal which has less than the predetermined value is detected at a single area node of a corresponding sensor pad, preciseness or resolution may be improved when detecting a touch generation position by determining that a touch occurs in the shared area node of the corresponding sensor pad.

Meanwhile, touch generation signals for a total of 7 nodes including four single area nodes and three shared area nodes may be obtained using only four sensor pads A, B, C, and D, and four signal lines (not shown) connected thereto. Accordingly, the touch detection operation may be performed at resolution of about twice the actual number of channels.

In the above description, selection of each of sensor pads A, B, and C, and signal supply and output signal acquisition for detecting a touch may be performed by the touch detection unit 210 (refer to FIG. 3), and confirmation of whether a touch occurs according to the output signal acquisition and determination of the touch generation position may be performed by the touch information processing unit 220. The touch detection unit 210 may perform a function of detecting a touch generation signal at a single area node and a touch generation signal at a shared area node, and the touch information processing unit 220 may perform a function of processing touch information generated from the single area node and the shared area node and determining whether a touch occurs at any position.

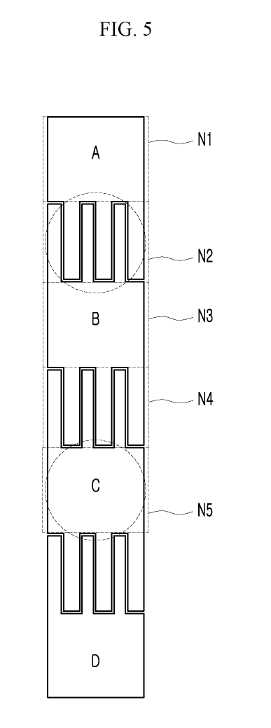

FIG. 5 is a diagram for describing another example of performing touch detection according to an exemplary embodiment of the present invention. In FIG. 5, an area formed by a circle drawn with a dashed line is an area in which an actual touch occurs.

In FIG. 5, as described above with reference to FIG. 4, the touch detecting operation may be performed on a first node N1, a third node N3, and a fifth node N5 with the self-capacitive method, and the touch detection operation may be performed on a second node N2 and a fourth node N4 with the mutual-capacitive method.

Since touches occur in the second node N2 in which the sensor pad A and the sensor pad B are arranged together and the fifth node N5 in which the sensor pad C is independently arranged, the touch generation signal of 50% may be obtained from the sensor pad A as a result of the touch detection operation performed on the first node N1 using the self-capacitive method. The touch generation signal of 100% may be obtained as a result of the touch detection operation performed on the second node N2 using the mutual-capacitive method. The touch generation signal of 50% may be obtained from the sensor pad B as a result of the touch detection operation performed on the third node N3, and a touch generation signal of 0% may be obtained as a result of the touch detection operation performed on the fourth node N4. Further, the touch generation signal of 100% may be obtained from the sensor pad C as a result of the touch detection operation performed on the fifth node N5 using the self-capacitive method.

Since the touch generation signal is not detected in the fifth node N4 which is a shared area node, a boundary between touch generation positions may be apparent through the fourth node N4. Accordingly, the touches may be confirmed as occurring in the second node N2 in which the sensor pad A and the sensor pad B are arranged together and the fifth node N5 in which the sensor pad C is independently arranged.

When a multi-touch occurs, as in the case of FIG. 2B in which a distance between touch generation positions is the same as that shown in FIG. 5, according to the conventional art, the multi-touch may be detected by determining whether a touch by one object occurs is detectable by comparing touch generation signals of a shared area node and a single area node, that is, by correcting touch coordinates, when processing the touch generation signals. However, according to the exemplary embodiment of the present invention, the multi-touch may be confirmed as occurring without a correction operation by software.

That is, a minimum distance between touch generation positions for exactly detecting a multi-touch may be smaller than that of the conventional art.

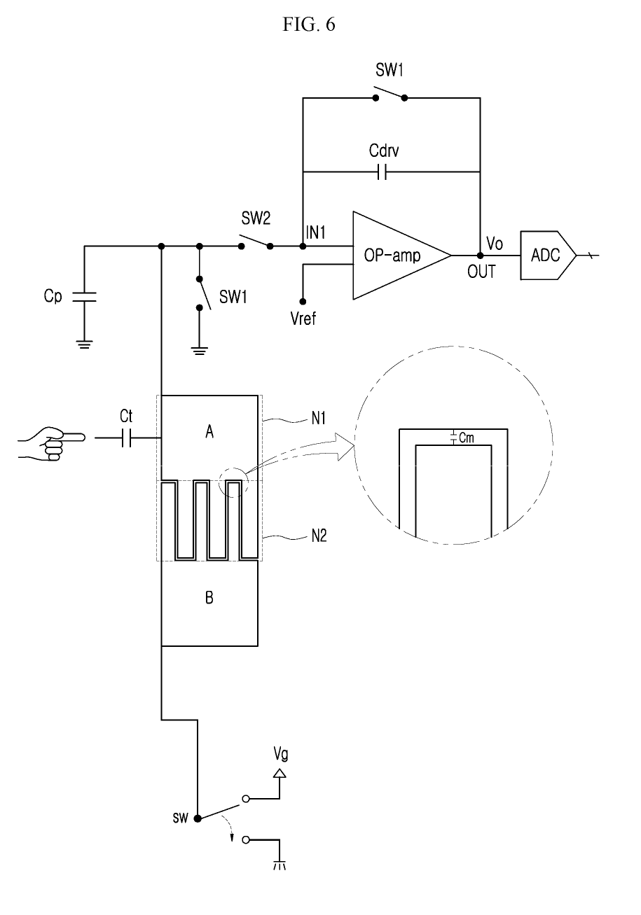

FIG. 6 is a circuit diagram illustrating principles of a self-capacitive method and a mutual-capacitive method in the touch detection method described with reference to FIGS. 4 and 5.

Referring to FIG. 6, a touch detection method will be described in the first node N1 in which the sensor pad A is independently arranged and in the second node N2 in which the sensor pad B is arranged together with the sensor pad A.

A touch capacitance Ct may be formed between a touch generation means and the sensor pad A. The sensor pad A may be selectively connected to a ground potential by a first switch SW1, and may be selectively connected to a first input terminal IN1 of an operational amplifier OP-amp. A driving capacitance Cdrv may be formed between the first input terminal IN1 and an output terminal OUT of the operational amplifier OP-amp, and the first switch SW1 may be connected to both ends of the driving capacitance Cdrv. Further, a reference voltage Vref may be input to a second input terminal of the operation amplifier OP-amp. Meanwhile, an unknown parasitic capacitance Cp may be formed in the sensor pad A. The first switch SW1, a second switch SW2, the driving capacitance Cdrv, the operational amplifier OP-amp, and an analog-to-digital converter (ADC) may be included in the touch detection unit 210 (refer to FIG. 3).

The touch detection operation may be performed on the first node N1 which is the single area node in which a portion of the sensor pad A is independently arranged with the self-capacitive method, and the self-capacitive method will be described below.

When the first switch SW1 is turned on after the sensor pad A is selected by a multiplexer (not shown) included in the touch detection unit 210, the sensor pad A may be reset by being connected to the ground potential, and both of the ends of the driving capacitance Vdrv may be reset to have the same potential. Accordingly, all of the parasitic capacitance Cp, the touch capacitance Ct, and the driving capacitance Cdrv may be initialized.

When the first switch SW1 is turned off and the second switch SW2 is turned on, a potential of the first input terminal IN1 of the operational amplifier OP-amp may be the same as the reference voltage Vref. When a normal state is reached, both of the touch capacitance Ct and the parasitic capacitance Cp may be in a state in which the touch capacitance Ct and the parasitic capacitance Cp are charged to the reference voltage Vref. In this case, a sum of the amounts of electric charges charged in the touch capacitance Ct and the parasitic capacitance Cp may be the same as the amount of electric charge charged in the driving capacitance Cdrv by the electric charge conversation law.

Since a potential difference of both of the ends of the driving capacitance Cdrv is 0 V and a potential of a node connected to the first input terminal IN1 of the operational amplifier OP-amp, which is one end of the driving capacitance Cdrv, is maintained as the reference voltage Vref before the second switch SW2 is turned on, a change amount ΔVo of a voltage Vo of the output terminal OUT of the operational amplifier OP-amp before and after a touch occurs may be the same as a voltage of both of the ends of the driving capacitance Cdrv after the second switch SW2 is turned on.

As described above, since the amount of electric charge charged in the driving capacitor Cdrv is the same as the sum of the amounts of electric charges charged in the touch capacitor Ct and the parasitic capacitor Cp, the voltage of both of the ends of the driving capacitor Vdrv may be proportional to that of the touch capacitor Ct.

Accordingly, the touch capacitor Ct formed at the sensor node A may be measured with the self-capacitive method using the change amount ΔVo of a voltage Vo of the output terminal OUT of the operational amplifier OP-amp.

Next, a touch detection operation performed on the second node N2 which is the shared area node in which the sensor pad A and the sensor pad B are arranged together will be described. The touch detection operation may be performed with the mutual-capacitive method.

In this case, the sensor pad A may be used as the reception electrode Rx, and the sensor pad B may be used as the transmission electrode Tx, or vice versa. Here, an example in which the sensor pad A and the sensor pad B are respectively used as the reception electrode Rx and the transmission electrode Tx will be described.

A mutual capacitance Cm may differ according to a flux between the sensor pad A and the sensor pad B, and when a touch occurs in the second node N2 in which the sensor pad A and the sensor pad B are arranged together, a corresponding flux may be partially absorbed by a touch generation means, and the mutual capacitance Cm having a specific amount of charges may be formed.

In a state in which the sensor pad A is selected by a multiplexer of the touch detection unit 210 when a potential of the sensor pad B is transiently changed, the mutual capacitance Cm between the sensor pad A and the sensor pad B may be changed.

Since the mutual capacitance Cm is connected in parallel to the touch capacitance Ct, when the first switch SW1 is turned off and the second switch SW2 is turned on, the amount of electric charges charged in the driving capacitance Cdrv may be the same as the sum of the amounts of electric charges charged in the parasitic capacitance Cp and the mutual capacitance Cm.

Accordingly, when the mutual capacitance Cm is changed, the amount of electric charges charged in the driving capacitance Cdrv may also be changed, and thus the voltage Vo of the output terminal OUT of the operational amplifier OP-amp may be changed.

Since values of the mutual capacitance Cm are different from each other when a touch does not occur and when a touch occurs in the second node N2, whether a touch occurs in the second node N2 and a touch generation state may be determined by detecting an output voltage Vo of the sensor pad A, that is, an increasing value or a decreasing value of the voltage Vo of the output terminal OUT of the operational amplifier OP-amp.

Meanwhile, a transient potential change operation may be performed with various methods on the sensor pad B. For example, when an operation of determining whether a touch occurs on the sensor pad B is not performed, the sensor pad B may be connected to a reference voltage Vg by a switch SW, and the transient potential change operation may be performed by transiently connecting the sensor pad B to another potential (for example, the ground potential) by controlling the switch SW.

The touch detection operation may not need to be sequentially performed on the single area node N1 and on the shared area node N2. The touch detection operation may be selectively performed on the shared area node N2, and for example, the touch detection operation using the self-capacitive method on all of the sensor pads may be performed on N frames (N is a natural number) and the touch detection operation using the mutual-capacitive method may be performed on the shared area node N2. Further, only when a touch generation signal is detected at an arbitrary sensor pad and the touch detection operation using the self-capacitive method is performed on the single area node N1, the touch detection operation using the mutual-capacitive method may be performed on the shared area node N2. The term “frame” may be a unit in which the touch detection operation is performed on all of the sensor pads.

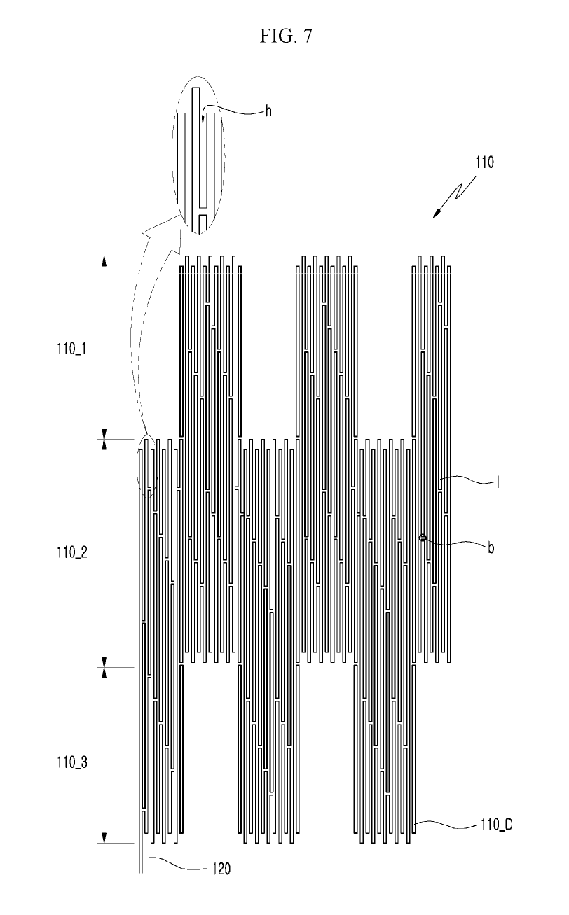

FIG. 7 is a diagram illustrating a detailed configuration of a sensor pad of the touch detection device according to an exemplary embodiment of the present invention.

Referring to FIG. 7, as described above, one sensor pad 110 may include the upper subpad 110_1, the middle subpad 110_2, and the lower subpad 110_3.

The middle subpad 110_2 may be formed in a rectangular shape. A plurality of grooves h may be formed in an inner direction of an area which is not in contact with the upper subpad 110_1 and the lower subpad 110_3 at edge regions of the top and the bottom thereof in one direction (desirably, the column direction) of the middle subpad 110_2. A longitudinal direction of the plurality of grooves h may be formed in parallel to the column direction in which the sensor pads 110 are arranged.

Depths of the plurality of grooves h may be formed to be different from each other. According to the exemplary embodiment, as shown in FIG. 7, when the plurality of grooves h are formed in parallel and to have a predetermined distance in the row direction of the middle subpad 110_2 of the sensor pad 110, the depths of the grooves h may be repeatedly and periodically increased and decreased in the row direction.

Meanwhile, the upper subpad 110_1 and the lower subpad 110_3 may be formed to have a plurality of bar type strips having longitudinal directions parallel to the column direction in which the sensor pads 110 are arranged, and the bar type strips may be electrically to an upper edge and a lower edge of the middle subpad 110_2 which is formed in the rectangular shape. For convenience of explanation, an example in which the upper subpad 110_1 and the lower subpad 110_2 are electrically connected to the middle subpad 110_2 is illustrated, but it may be desirable for the middle subpad 110_2, the upper subpad 110_1, and the lower subpad 110_2 to be integrally manufactured.

The same grooves h as those formed in the middle subpad 110_2 may also be formed at upper edges (that is, one ends) of the bar type strips configuring the upper subpad 110_1 and lower edges (that is, one ends) of the bar type strips configuring the lower subpad 110_3. The longitudinal direction of the plurality of grooves h formed in the upper subpad 110_1 and the lower subpad 110_3 may also be in parallel to the column direction in which the sensor pads 110 are arranged. The depths of the grooves h may be formed to be repeatedly and periodically increased or decreased along the row direction in which the sensor pads 110 are arranged.

As a result, the plurality of grooves h having longitudinal directions parallel to the column direction in which the sensor pads 110 are arranged may be formed in at least one portion of an edge of the sensor pad 110.

Meanwhile, a plurality of slits I having longitudinal directions parallel to the column direction in which the sensor pads 110 are arranged may be formed in an area in which the grooves are not formed among areas of the upper subpad 110_1, the middle subpad 110_2, and the lower subpad 110_3.

A width of the slit I may be formed to be the same as that of the groove h, and each of both ends of the slit may be formed to be adjacent to bottoms of different grooves h. When a portion at which one end of the slit I is adjacent to the bottom of the groove h is defined as a bridge b, the sensor pad 110 may be divided by the slits I and the grooves h, and may be configured as a plurality of strip pads which are electrically connected to each other through bridges b.

As described above, each of the sensor pads 110 may be connected to the driving unit 200 (refer to FIG. 3) through the one signal line 120. However, when the grooves h and the slits I are not formed in the sensor pad 110, patterns of an area in which the signal lines 120 are arranged side by side and an area in which the sensor pad 110 is arranged may be different. An area in which the plurality of signal lines 120 are arranged side by side may have a shape in which a plurality of strips are arranged side by side to have a predetermined distance, but the area which the sensor pad 110 is arranged may have a shape in which one large conductive plate is arranged. Further, generally, the touch panel 100 (refer to FIG. 3) may be arranged on a display device, and light transmission characteristics between light emitted by the display device toward both areas may be different due to a light transmission difference between the area in which the signal lines 120 are arranged and the area in which the sensor pad 110 is arranged.

In the exemplary embodiment of the present invention, the grooves h and the slits I may be formed in the sensor pad 110, the widths of the groove h and the slit I may be formed to be the same as a distance between the signal lines 120, and a distance between the grooves h which are parallel to each other and a distance between the slits I may be formed to be the same as a width of the signal line 120, and thus the patterns of the area in which the sensor pad 110 is arranged and the area in which the signal lines 120 are arranged may be the same.

Further, accordingly, even when the touch panel 100 is stacked on a display device, the light transmission difference between the area in which the sensor pad 110 is arranged and the area in which the signal lines 120 are arranged may be removed.

Meanwhile, a portion of the sensor pad 110 may be damaged by static electricity during a manufacturing process or operation. Since the sensor pad 110 is the same as that the plurality of strips that are connected to each other through the bridge b and are formed even when the portion is damaged, the sensor pad 110 may operate normally from the viewpoint of the entire sensor pad 110.

According to an exemplary embodiment of the present invention, dummy pads 110_D may also be formed at side edges of the bar type strips configuring the upper subpad 110_1 and the lower subpad 110_3 of the sensor pad 110.

The dummy pads 110_D may be formed to be spaced apart from each other and have a predetermined distance from the bar type strip of the sensor pad 110, and it may be desirable for the distance to be the same as the widths of the groove h and the slit I. A longitudinal direction of the dummy pad 110_D may be arranged to be parallel to the column direction of the sensor pad 110.

As described above, the bar type strips of one sensor pad may overlap bar type strips of another sensor pad in the areas of the upper subpad 110_1 and the lower subpad 110_3, and the dummy pad 110_D may be formed to maximally prevent formation of parasitic capacitance and signal interference between the sensor pads when the bar type strips of the other sensor pad are overlapped. Accordingly, the dumpy pad 110_D may be arranged at an edge adjacent to the bar type strips of the other sensor pad among the side edges of the bar type strips configuring the upper subpad 110_1 and the lower subpad 110_3 of the sensor pad 110. That is, when the bar type strips of the first sensor pad 110 and bar type strips of a second sensor pad 110 are arranged to be adjacent to each other, the dummy pad 110_D may be formed therebetween.

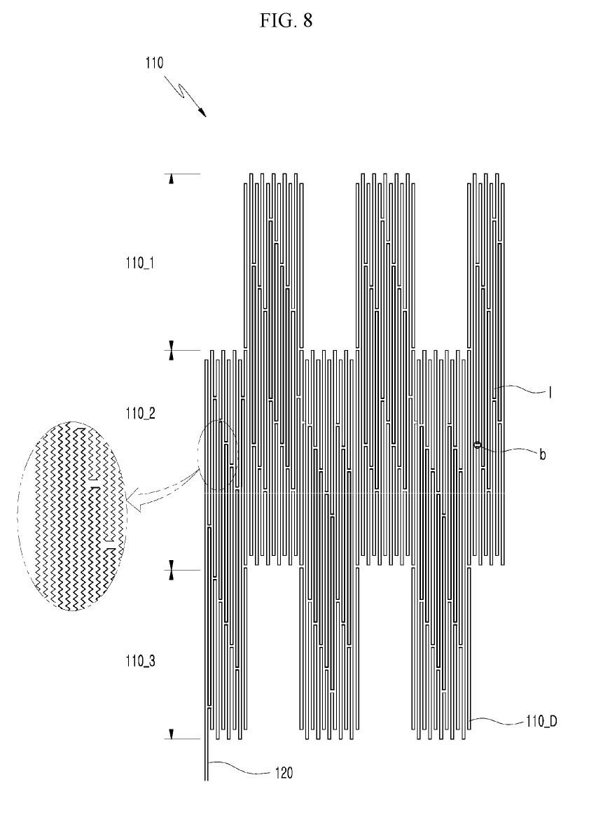

FIG. 8 is a diagram illustrating a configuration of a sensor pad according to another exemplary embodiment of the present invention.

Referring to FIG. 8, in a sensor pad 110 of the present invention, all line segments which are parallel to a column direction may be formed in a saw pattern. That is, side edges of bar type strips configuring an upper subpad 110_1 and a lower subpad 110_3 and side edges of a middle subpad 110_2 of the sensor pad 110, may be formed in the saw pattern, and a line segment which is parallel to a longitudinal direction of a line segment configuring an inner wall of a groove h and a line segment configuring a slit I, of the entire sensor pad 110 may be formed in a saw pattern. In other words, as described above, the sensor pad 110 may include a plurality of strip pads which are separated from each other by the groove h and the slit I, but all of line segments in the longitudinal direction may be formed in a saw pattern in the plurality of strip pads.

Meanwhile, accordingly, a line segment in a longitudinal direction of a dummy pattern 110_D may also be formed in a saw pattern, and a signal line 120 may also be formed in a saw pattern.

A touch panel may be stacked on a display device and installed therein, the display device may include a backlight, a polarizing plate, a substrate, a liquid crystal layer, a pixel layer, etc. The pixel layer may refer to a color filter formed on a surface (an upper surface or a lower surface) of the liquid crystal layer for displaying an image and producing color in the liquid crystal display device in units of pixels of red, green, and blue (hereinafter, R, G, and B).

The pixel layer may include a plurality of pixels including subpixels R, G, and B, and when the sensor pad 110 and a line segment of the signal line 120 which are arranged on an upper touch panel are formed in a straight line, an area in which each sensor pad 110 and the signal line 120 overlap the subpixels R, G, and B may be different according to each area. Accordingly, a color temperature and a color of each pixel may be different according to a light transmission difference between the sensor pad 110 and the signal line 120 that overlap each pixel. According to the exemplary embodiment shown in FIG. 8, when a row or column direction of the subpixels R, G, and B, the line segments of the sensor pad 110, and the signal line 120 are formed to have a predetermined angle, the touch panel 100 is divided into a plurality of unit regions as the angle is repeatedly and periodically changed and an area in which the subpixels R, G, and B and the sensor pad 110 or the signal line 120 overlap in each unit area may not have a great difference. Accordingly, the color temperature difference and the color difference according to area throughout the entire touch panel 100 can be minimized.

According to the exemplary embodiment of the present invention, when the sensor pads are arranged to be interlocked, whether a touch occurs on an interlocked area can be exactly determined, and thus accuracy of touch detection can be improved.

Further, since whether a touch occurs in an area in which a sensor pad is independently arranged or an area in which different sensor pads are interlocked is exactly determined, a touch position can be exactly detected when a multi-touch occurs at positions which are adjacent to each other.

Moreover, a light transmission characteristic difference of each area of a touch panel can be minimized by forming grooves and slits to have a predetermined distance and width in a sensor pad, and a color temperature difference and color difference occurring in the touch panel can be minimized by forming line segments configuring the sensor pad in a saw pattern.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent

1. A touch detection apparatus comprising:
a plurality of sensor nodes comprising a single area node configured as a portion of a single sensor pad among sensor pads arranged in a plurality of rows and columns in a single layer, and a shared area node configured so that portions of at least two sensor pads are alternately arranged;
a touch detection unit configured to detect a first touch generation signal generated according to a change of a touch capacitance generated between each of the sensor pads and a touch generation means, and to detect a second touch generation signal generated according to a change of a mutual capacitance generated between the sensor pads adjacent in a first direction; and
a touch information processing unit configured to process touch information generated in the single area node and touch information generated in the shared area node based on the first and second touch generation signals.

2. The touch detection apparatus of claim 1, wherein at least one end of each of the sensor pads is formed to have a plurality of bar type strips extended in the first direction, and the sensor pads adjacent in the first direction configure the shared area node in which the plurality of bar type strips are arranged to be interlocked.

3. The touch detection apparatus of claim 2, wherein a dummy pad having longitudinal direction parallel to the first direction is formed at an edge of the plurality of bar type strips in a second direction perpendicular to the first direction.

4. The touch detection apparatus of claim 1, wherein a plurality of grooves are formed at an edge of the sensor pad in the first direction in an inner direction of the sensor pad, and a longitudinal direction of the grooves is parallel to the first direction.

5. The touch detection apparatus of claim 4, wherein depths of the grooves are formed to be periodically increased or decreased based on the second direction perpendicular to the first direction.

6. The touch detection apparatus of claim 1, wherein one or more slits having longitudinal directions parallel to a column direction in which the sensor pad is arranged are formed inside an area of the sensor pad.

7. The touch detection apparatus of claim 1, wherein at least a portion of line segments parallel to the first direction configuring the sensor pad is formed in a saw pattern.

8. The touch detection apparatus of claim 1, wherein each of the sensor pads is connected to a driving unit including the touch detection unit and the touch information processing unit through a signal line, and the number of the sensor pads is smaller than the number of the sensor nodes.

9. The touch detection apparatus of claim 1, wherein the touch detection unit detects the first touch generation signal using a self-capacitive method in the single area node and detects the second touch generation signal using a mutual-capacitive method in the shared area node.

10. The touch detection apparatus of claim 1, wherein, when the first touch generation signal and the second touch generation signal detected in the single area node and the shared area node at the same sensor pad have a predetermined value or more, the touch information processing unit determines that a multi-touch occurs at the same sensor pad.

11. The touch detection apparatus of claim 1, wherein, when the second touch generation signal is detected in all shared area nodes of a specific sensor pad and the first touch generation signal detected in the specific sensor pad has less than a predetermined value, the touch information processing unit determines that a multi-touch occurs in which a touch occurs in each of the shared area nodes of the specific sensor pad.

12. The touch detection apparatus of claim 1, wherein the touch detection unit detects the second touch generation signal based on a change value of an output voltage of another sensor pad generated by transiently changing a potential of the specific sensor pad among the sensor pads configuring the shared area node.

13. A touch detection method comprising:
detecting a first touch generation signal according to a change of a touch capacitance on a plurality of sensor pads which are arranged in a plurality of rows and columns in a single layer and form the touch capacitance through a relationship with a touch generation means;
detecting a second touch generation signal according to a change of a mutual capacitance between the sensor pads adjacent in a first direction; and
processing touch information generated in a single area node configured as a portion of a single sensor pad and a shared area node, in which portions of at least two sensor pads are configured to be alternately arranged, based on the first and second generation signals.

14. The touch detection method of claim 13, wherein the first touch generation signal is detected using a self-capacitive method, and the second touch generation signal is detected using a mutual-capacitive method.

15. The touch detection method of claim 14, wherein the detecting of the first touch generation signal and the detecting of the second touch generation signal are alternately performed.

16. The touch detection apparatus of claim 2, wherein at least a portion of line segments parallel to the first direction configuring the sensor pad is formed in a saw pattern.

17. The touch detection apparatus of claim 3, wherein at least a portion of line segments parallel to the first direction configuring the sensor pad is formed in a saw pattern.

18. The touch detection apparatus of claim 4, wherein at least a portion of line segments parallel to the first direction configuring the sensor pad is formed in a saw pattern.

19. The touch detection apparatus of claim 6, wherein at least a portion of line segments parallel to the first direction configuring the sensor pad is formed in a saw pattern.
